(19) United States
(12) Patent Application Publication
(10) Pub. No.: US 2013/0170127 A1
(43) Pub. Date: Jul. 4, 2013

(54) MEMORY ASSEMBLY

(71) Applicant: TEN-CHEN HO, Tu-Cheng (TW)

(72) Inventor: TEN-CHEN HO, Tu-Cheng (TW)

(73) Assignee: HON HAI PRECISION INDUSTRY CO., LTD., Tu-Cheng (TW)

(21) Appl. No.: 13/400,761

(22) Filed: Feb. 21, 2012

(30) Foreign Application Priority Data
Dec. 28, 2011 (CN) 201110447346.2

(51) Int. Cl. G06F 1/20; G06F 1/16

(52) U.S. Cl. 361/679.31

(57) ABSTRACT

A computer includes an enclosure, a motherboard, a memory slot, a memory, a heat-dissipating memory, and a grounding element. The enclosure includes a cover. The motherboard is received in the enclosure. The memory slot is mounted on the motherboard. The memory is inserted into the memory slot. The heat-dissipating member partially wraps the memory. The grounding element is mounted on an inner surface of the cover. When the cover covers a base of the enclosure, the grounding element elastically abuts the heat-dissipating member, to electrically connect the heat-dissipating member to the cover and ground.

### CROSS-REFERENCE TO RELATED ART

The present application is related to a co-pending U.S. patent application, titled “MEMORY ASSEMBLY”, with the application Ser. No. 13/370,813 (Attorney Docket No. US43915), assigned to the same assignee as the present application, and the disclosure of which is incorporated herein by reference.

### BACKGROUND

1. Technical Field

The present disclosure relates to a memory assembly.

2. Description of Related Art

In many server computers or personal computers, heat sinks are assembled to memories to dissipate heat from the memories. However, electromagnetic waves from the memories may couple with the heat sinks creating an antenna effect, producing electromagnetic interference.

### BRIEF DESCRIPTION OF THE DRAWINGS

Many aspects of the present embodiments can be better understood with reference to the drawings. The components in the drawings are not necessarily drawn to scale, the emphasis instead being placed upon clearly illustrating the principles of the present disclosure. Moreover, in the drawings, all the views are schematic, and like reference numerals designate corresponding parts throughout the several views.

FIG. 1 is an isometric view of a first exemplary embodiment of a computer, wherein a cover of the computer is open.

FIG. 2 is similar to FIG. 1, but shows the cover closed.

FIG. 3 is a cross-sectional view of the computer and cover of FIG. 2, taken along the line of III-III.

FIG. 4 is an isometric view of a second exemplary embodiment of a computer, wherein a cover of the computer is open.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean at least one.

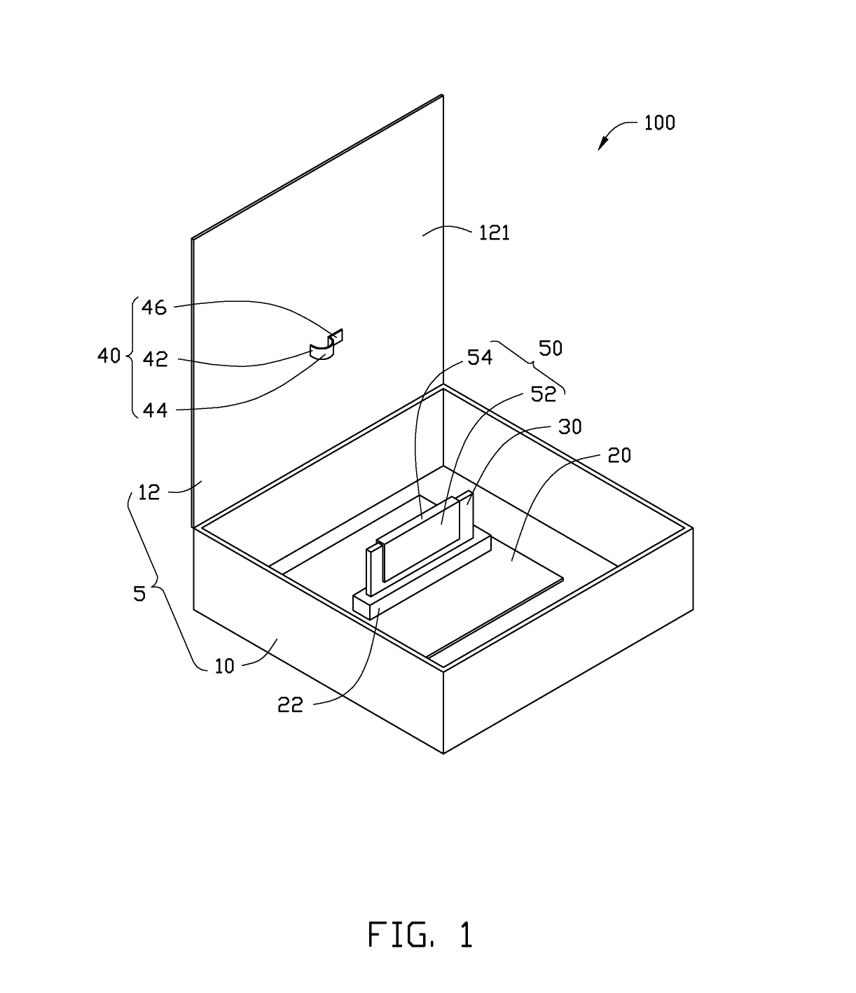

Referring to FIG. 1, a first embodiment of a computer 100 includes an enclosure 5, a motherboard 20, a memory slot 22, a memory 30, a conductive grounding element 40, and a heat-dissipating member 50.

The enclosure 5 includes a base 10 accommodating the motherboard 20, and a cover 12 detachably mounted to the base 10 to cover the motherboard 20. The memory slot 22 is mounted on the motherboard 20 to connect to the memory 30, thereby allowing communication between the memory 30 and other elements on the motherboard 20.

The heat-dissipating member 50 is substantially U-shaped, and includes two opposite boards 52, and a connection portion 54 connected between top sides of the boards 52. The heat-dissipating member 50 is assembled to the memory 30. The boards 52 tightly abut opposite side surfaces of the memory 30. The connection portion 54 tightly abuts the top surface of the memory 30.

The grounding element 40 is fixed to an inner surface 121 of the cover 12 and in profile resembles a question mark without the bottom period. A first terminal 42 of the grounding element 40 is electrically connected to the inner surface 121. A middle portion of the grounding element 40 is curved to form an arced abutting portion 44. There is a distance between a second terminal 46 of the grounding element 40 opposite to the first terminal 42 and the inner surface 121 of the cover 12.

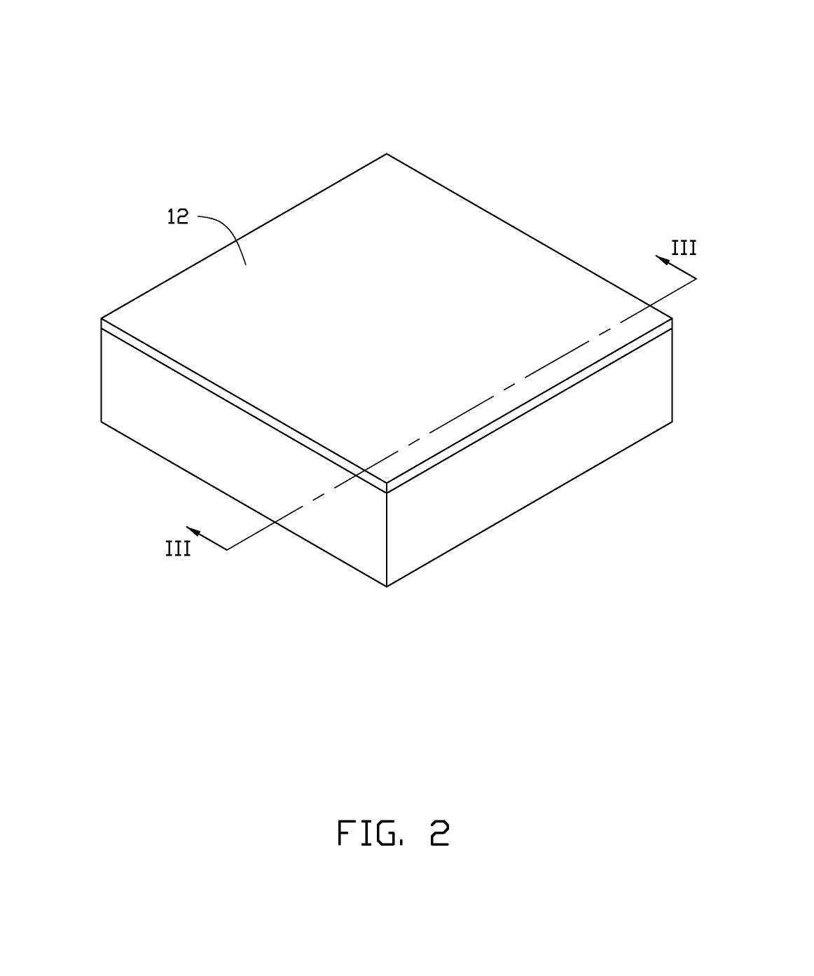

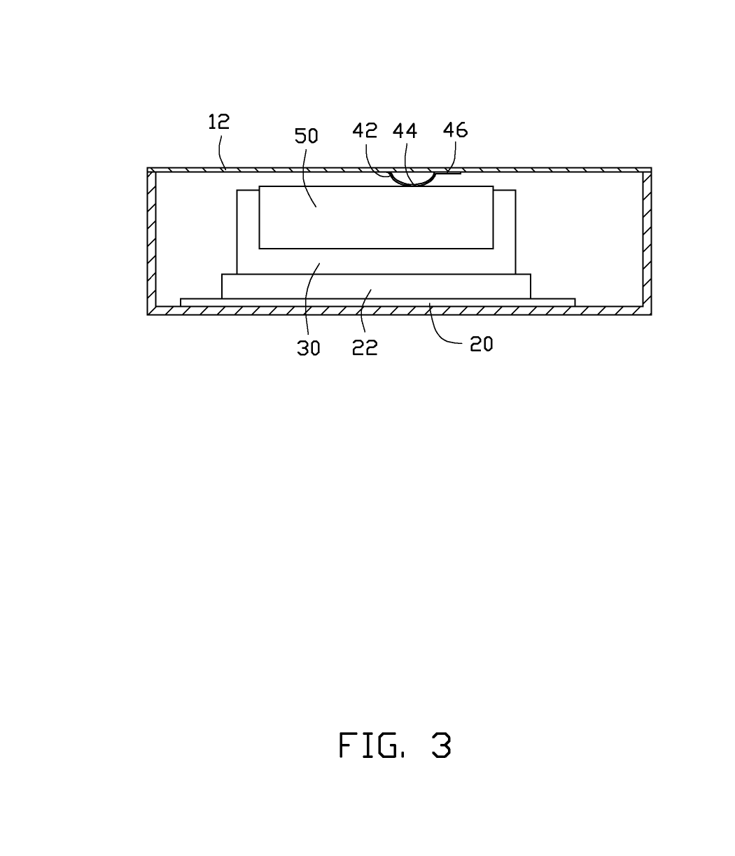

Referring to FIGS. 2 and 3, in use, the cover 12 is closed to cover the base 10, whereupon the second terminal 46 of the grounding element 40 touches the inner surface 121 of the cover 12, and the abutting portion 44 of the grounding element 40 abuts and deforms slightly against the connection portion 54 of the heat-dissipating member 50, to electrically connect the heat-dissipating member 50 to the cover 12. When the memory 30 operates, electromagnetic (EM) waves from the memory 30 are directly grounded through the grounding element 40 and the enclosure 5, thereby avoiding having the EM waves coupling with and radiating from the heat-dissipating member 50.

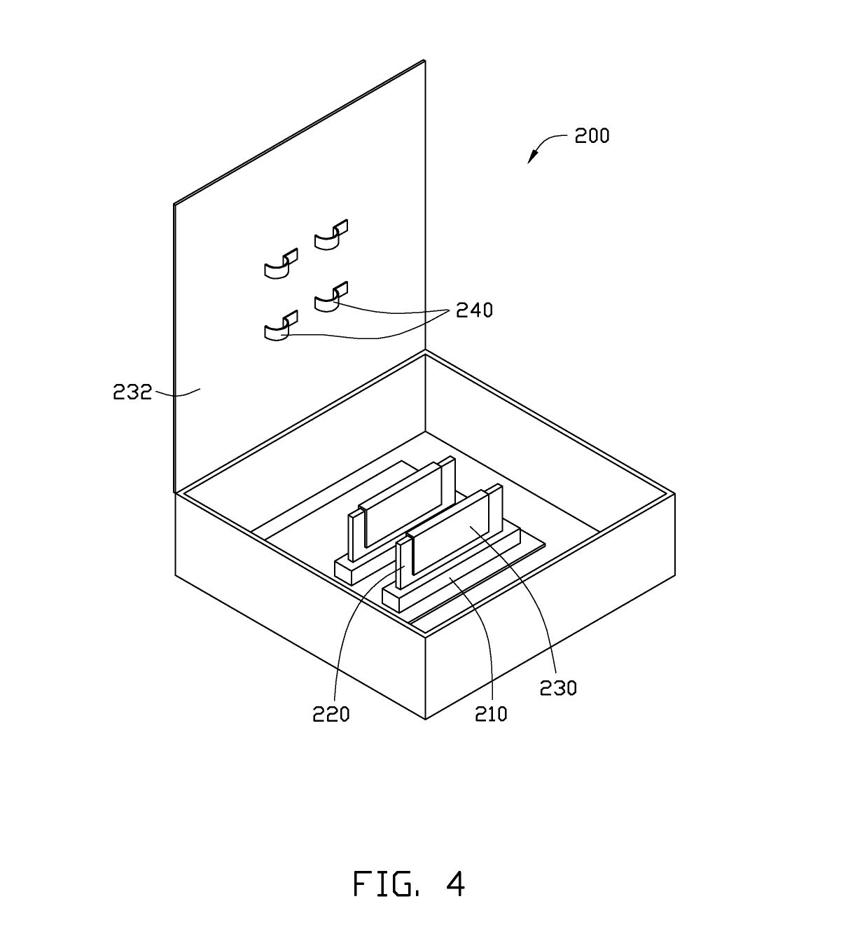

Referring to FIG. 4, a second embodiment of a computer 200 is similar to the first embodiment of the computer 100. In the second embodiment, the computer 200 includes two memory slots 210, two memories 220, two heat-dissipating members 230, and two groups of grounding elements. Each group of grounding elements corresponds to one heat-dissipating member 230. Each group of grounding elements includes two grounding elements 240. The grounding elements 240 function in the second embodiment as the grounding element 40 functions in the first embodiment.

Although numerous characteristics and advantages of the embodiments have been set forth in the foregoing description, together with details of the structure and function of the embodiments, the disclosure is illustrative only, and changes may be made in detail, especially in the matters of shape, size, and arrangement of parts within the principles of the embodiments to the full extent indicated by the broad general meaning of the terms in which the appended claims are expressed.

What is claimed is:

1. A computer comprising:
an enclosure comprising a base, and a detachable cover;
a motherboard received in the base;
a memory slot mounted on the motherboard;
a memory inserted into the memory slot;
a heat-dissipating member partially wrapping the memory; and
a grounding element mounted on an inner surface of the cover of the enclosure;
wherein when the cover covers the base, the grounding element elastically abuts the heat-dissipating member, to electrically connect the heat-dissipating member to the cover.

2. The computer of claim 1, wherein the grounding element is a metal elastic piece, a first terminal of the grounding element is electrically connected to the inner surface of the cover, a middle portion is curved to form an arced abutting portion to abut a top of the heat-dissipating member.

3. The computer of claim 2, wherein there is a distance between a second terminal of the grounding element opposite to the first terminal and the inner surface of the cover, when the cover covers the base, the second terminal of the grounding element touches the inner surface of the cover, and the abutting portion of the grounding element elastically abuts the heat-dissipating member, to electrically connect the heat-dissipating member to the cover.

4. A memory assembly to be mounted in a computer, the memory assembly comprising:
a memory inserted into a memory slot of a motherboard of the computer;
a heat-dissipating member partially wrapping the memory; and
a grounding element mounted on an inner surface of a cover of an enclosure of the computer;
wherein when the cover covers a base of the enclosure, the grounding element elastically abuts the heat-dissipating member, to electrically connect the heat-dissipating member to the cover.

5. The memory assembly of claim 4, wherein the grounding element is a metal elastic piece, a first terminal of the grounding element is electrically connected to the inner surface of the cover, a middle portion is curved to form an arced abutting portion to abut a top of the heat-dissipating member.

6. The memory assembly of claim 5, wherein there is a distance between a second terminal of the grounding element opposite to the first terminal and the inner surface of the cover, when the cover covers the base, the second terminal of the grounding element touches the inner surface of the cover, and the abutting portion of the grounding element elastically abuts the heat-dissipating member, to electrically connect the heat-dissipating member to the cover.
